(19) United States
(12) Patent Application Publication
(10) Pub. No.: US 2015/0202629 A1
(43) Pub. Date: Jul. 23, 2015

(54) GYRATORY CRUSHER BEARING

(71) Applicant: SANDVIK INTELLECTUAL PROPERTY AB, Sandviken (SE)

(72) Inventors: Niklas Aberg, Sodra Sandby (SE); Bengt-Arne Eriksson, Svedala (SE)

(21) Appl. No.: 14/417,549

(22) PCT Filed: Jun. 19, 2013
(86) PCT No.: PCT/EP2013/062764

§ 371 Date: Jan. 26, 2015

(30) Foreign Application Priority Data
Jul. 27, 2012 (EP) 12178350.0

(51) Int. Cl. B02C 2/00; B02C 2/04

(52) U.S. Cl. CPC B02C 2/005; B02C 2/04

(57) ABSTRACT

A gyratory crusher includes an eccentric provided with a first envelope surface and a second envelope surface. A third envelope surface extends about a central axis and has a longitudinal extension along the central axis. A first slide bearing and a second slide bearing are provided between the first and third envelope surfaces. The first and second slide bearings are vertically separated from each other such that a distance-to-height quotient (VDi/H1; VDi/H2) of the first or second slide bearing that has the greatest height (H1; H2) is greater than 0.8.

### FIELD OF THE INVENTION

The present invention relates to a gyratory crusher comprising a crushing head provided with a first crushing shell, a frame provided with a second crushing shell, wherein the first and second crushing shells between them define a crushing gap, the gyratory crusher further comprising an eccentric provided with a first envelope surface and a second envelope surface, the second envelope surface being eccentrically arranged relative to the first envelope surface.

### BACKGROUND OF THE INVENTION

A gyratory crusher of the kind stated above can be used for crushing, for example, ore and rock material into smaller size.

U.S. Pat. No. 3,325,108 A discloses a gyratory crusher having a main frame forming an upstanding housing with a supporting flange for the bowl structure at the upper end. The main frame is connected to a centre hub by a web structure. The centre hub supports an eccentric. The eccentric is provided with a ring gear, which in turn is driven by a pinion on a drive shaft. When the eccentric is rotated the crushing head will move in a gyratory movement.

A similar gyratory crusher is known from US2003/136865A1. This crusher includes a frame, a shaft supported by the frame, and a head coupled to the shaft. An eccentric is rotatably coupled to the shaft and an eccentric bushing is coupled to the eccentric. Similar gyratory crushers are also known from e.g. US2008/203203A1 and WO2010/071553A1.

However, there is a need to reduce the weight of gyratory crushers. There is also a need to reduce the investment and operating costs of such crushers, and to increase their service interval. There is also a need to increase the stability of bearing system taking up crushing forces with varying location in the crushing chamber.

### SUMMARY OF THE INVENTION

It is an object of the present invention to solve, or at least mitigate, parts or all of the above mentioned problems.

To this end, there is provided a gyratory crusher comprising a crushing head provided with a first crushing shell, a frame provided with a second crushing shell, wherein the first and second crushing shells between them define a crushing gap, the gyratory crusher further comprising an eccentric provided with a first envelope surface and a second envelope surface, the second envelope surface being eccentrically arranged relative to the first envelope surface, and a third envelope surface extending about a central axis and having a longitudinal extension along said central axis, wherein the first envelope surface of the eccentric being journalled to the third envelope surface and being adapted to rotate about said central axis, and the second envelope surface of the eccentric being journalled to the crushing head, whereby rotation of the eccentric will provide a gyratory movement to the crushing head, wherein a first slide bearing and a second slide bearing are provided between the first and third envelope surfaces, and wherein the first and second slide bearings are vertically separated from each other along said central axis a distance such that a distance-to-height quotient (VDi/H1, VDi/H2) of the first or second slide bearing that has the greatest height is greater than 0.8. More preferably, the distance-to-height quotient (VDi/H1, VDi/H2) of the first or second slide bearing that has the greatest height is greater than 1.0, and even more preferably greater than 1.3. Preferably, the distance-to-height quotient (VDi/H1, VDi/H2) of the first or second slide bearing that has the greatest height is less than 6.0.

It may be especially noted that respective envelope surface may have one and the same diameter along its extension along the centre axis or that respective envelope surface may have a diameter that varies along the centre axis.

This is exemplified in the disclosed embodiment, where the first and third envelope surfaces have diameters that do not vary along the centre axis (i.e. the diameter D1 and D2 of the first and second slide bearings are the same). In the disclosed embodiment second and fourth envelope surfaces have diameters that do vary along the centre axis (i.e. the diameter D3 and D4 of third and fourth slide bearings are not the same).

It has surprisingly been found that the weight and cost of the crusher may be significantly reduced without sacrificing the capacity of the crusher when making use of the inventive design indicated above. It has been found that two or more slide bearings having a comparably limited height and being separated a certain distance from each other are able to exhibit the corresponding stability and load carrying capacity as the previously used large slide bearings. This will result in savings in both cost and weight. Moreover, the use of two or more slide bearings having a comparably limited height and being separated a certain distance from each other will result in a reduction of the friction losses in the bearings. Another benefit is that it is possible to design the two or more slide bearings with different diameters and/or different heights thereby coming closer to optimising their design to a particular load case.

According to one embodiment, the first and second slide bearings each has a respective height along and a respective diameter about said central axis such that a height-to-diameter quotient (H1/D1, H2/D2) of each of the first and second slide bearings is less than 0.8, more preferably less than 0.7, and most preferably less than 0.6. Thereby the cost and weight of the crusher may be reduced even further.

According to one embodiment, the height-to-diameter quotient (H1/D1, H2/D2) of each of the first and second slide bearing is more than 0.12. Thereby the load carrying capacity is taken into consideration.

According to one embodiment, the crushing head and frame are vertically movable relative to each other so as to allow changing the width of the crushing gap, wherein a quotient (HL/D) between the maximum vertical travel length (HL) of the crushing head and the horizontal diameter (D) of the crushing head exceeds 0.16, preferably exceeds 0.18, and even more preferably exceeds 0.24. Instead of, or in combination with a cost and weight reduction, the comparably small bearing height may be benefitted from by increasing the available vertical travel length of the crushing. Thereby, it is possible to use thicker crushing shells, which enables prolonged replacement intervals of the crushing shells.

According to one embodiment, the second envelope surface of the eccentric is journalled to a fourth envelope surface of the crushing head, wherein a third and a fourth slide bearing are provided between the second and fourth envelope surfaces. This way the inventive concept may be used also for the journaling between these two envelope surfaces. Thereby the cost and weight of the crusher may be reduced even further, without sacrificing the load carrying capacity.

According to one embodiment, the third and fourth slide bearings each has a respective height along and a respective diameter about said central axis such that a height-to-diameter quotient (H3/D3, H4/D4) of each of the third and fourth slide bearing is less than 0.45, preferably less than 0.35. Thereby the cost and weight of the crusher may be reduced even further.

According to one embodiment, the third and fourth slide bearings are vertically separated from each other along said central axis a distance such that a distance-to-height quotient (VDo/H3, VDo/H4) of the third or fourth slide bearing that has the greatest height is greater than 0.8, more preferably greater than 1.0. Thereby the cost and weight of the crusher may be reduced even further, without sacrificing the load carrying capacity. Preferably, the distance-to-height quotient (VDo/H3, VDo/H4) of the third or fourth slide bearing that has the greatest height is less than 6.0.

According to one embodiment, the height-to-diameter quotient (H3/D3; H4/D4) of each of the third and fourth slide bearing is more than 0.08. Thereby the load carrying capacity is taken into consideration.

According to one embodiment, the third envelope surface is an outwardly facing envelope surface of a central shaft body.

According to one embodiment one or several, or even all, of the slide bearings has a Sommerfeld number, S, which is less than 120. Preferably, the Sommerfeld number, S, of the slide bearing is less than 70, more preferably less than 40, and even more preferably less than 20. Such values of the Sommerfeld number, S, of the slide bearing has been found to improve the capacity of the slide bearing to operate at high crushing loads also at low height-to-diameter quotients H1/D1, H2/D2, H3/D3, H4/D4, respectively. Preferably, the Sommerfeld number is higher than 2, more preferably higher than 3, and even more preferably above 4.

According to one embodiment one or several, or even all, of the slide bearings has a relative clearance ξ of between about 2*10⁻⁴ and about 5*10⁻³.

A further object of the present invention is to provide a slide bearing lining for rotatably mounting a crushing head to a crusher frame via an eccentric. This object is achieved by a gyratory crusher slide bearing lining for rotatably mounting a crushing head to a crusher frame via an eccentric, wherein the slide bearing lining is a first or a second slide bearing lining adapted to form part of a set of slide bearing linings comprising first and second slide bearing linings adapted to be mounted vertically separated from each other a distance (VDi, VDo) such that a distance-to-height quotient (VDi/H1, VDi/H2; VDo/H3, VDo/H4) of the first or second slide bearing lining that has the greatest height (H1, H2; H3, H4) is greater than 0.8, more preferably greater than 1.0, and even more preferably greater than 1.3. An advantage of this slide bearing lining is that it provides for good stability and load carrying capacity of the gyratory crusher to which it is mounted. The slide bearing lining has a low weight which makes maintenance and replacement easier. Preferably, the distance-to-height quotient (VDi/H1, VDi/H2; VDo/H3, VDo/H4) of the first or second slide bearing that has the greatest height is less than 6.0.

According to one embodiment the slide bearing lining is adapted to form part of a set of slide bearing linings adapted to be arranged between a crusher shaft and the eccentric. Preferably, the slide bearing lining has a height (H1, H2) and a diameter (D1, D2) such that a height-to-diameter quotient (H1/D1; H2/D2) of the slide bearing lining is less than 0.8, more preferably less than 0.7, and most preferably less than 0.6.

According to one embodiment the slide bearing lining is adapted to form part of a set of slide bearing linings adapted to be arranged between the eccentric and the crushing head. Preferably, the slide bearing lining has a height (H3, H4) and a diameter (D3, D4) such that a height-to-diameter quotient (H3/D3; H4/D4) of the slide bearing lining is less than 0.45, more preferably less than 0.35.

A further object of the present invention is to provide a gyratory crusher eccentric for rotatably mounting a crushing head to a crusher frame via the eccentric. This object is achieved by a gyratory crusher eccentric, which comprises first and second slide bearings that are vertically separated from each other a distance (VDi; VDo) such that a distance-to-height quotient (VDi/H1, VDi/H2; VDo/H3, VDo/H4) of the first or second slide bearing that has the greatest height (H1, H2; H3, H4) is greater than 0.8, more preferably greater than 1.0, and even more preferably greater than 1.3. The first and second slide bearings may be arranged on the inside of the eccentric, and as such be inner slide bearings, and/or may be arranged on the outside of the eccentric, and as such be outer slide bearings. Thus, the eccentric could comprise slide bearings on its inner side, on its outer side, or both on its inner and outer sides. An advantage of this gyratory crusher eccentric is that it provides for low weight, good stability and efficient load carrying capacity of the gyratory crusher to which it is mounted. Preferably, the distance-to-height quotient (VDi/H1, VDi/H2; VDo/H3, VDo/H4) of the first or second slide bearing that has the greatest height is less than 6.0.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, where the same reference numerals will be used for similar elements, wherein:

FIG. 1 shows schematically a gyratory crusher according to a first embodiment.

FIG. 2 is a partial enlargement of an eccentric sleeve and the associated slide bearings.

### DETAILED DESCRIPTION OF PREFERRED EMBODIMENTS

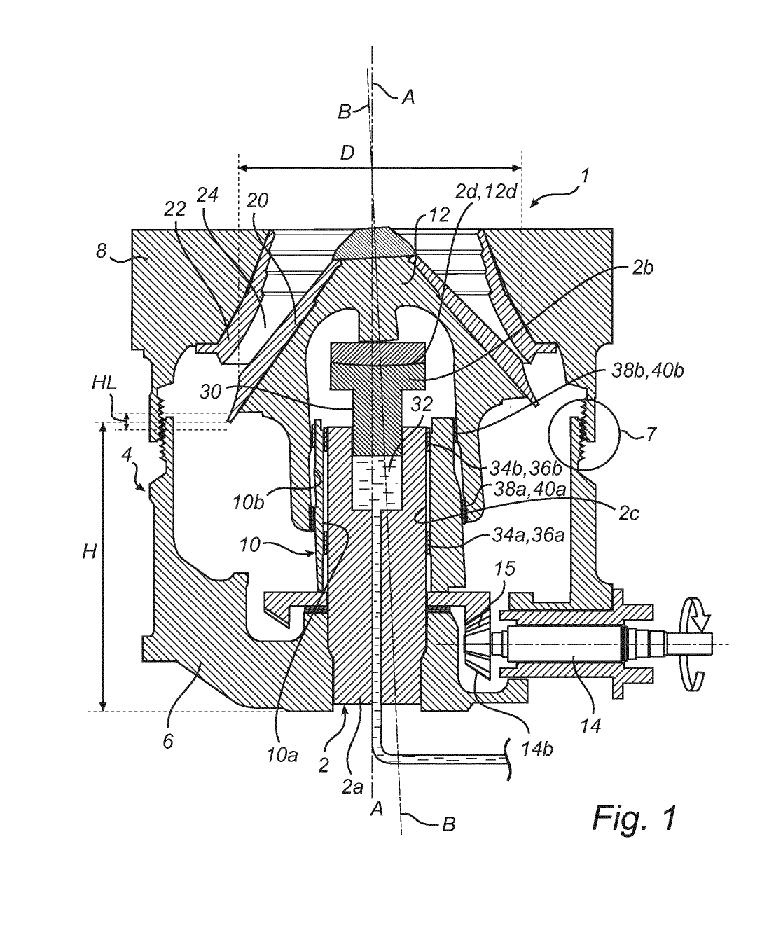

FIG. 1 schematically illustrates a gyratory crusher 1 in section. The gyratory crusher 1 has a vertical shaft 2, and a frame 4 comprising a frame bottom part 6 and a frame top part 8. The vertical shaft 2 comprises a lower portion 2a, which is mounted to the frame bottom part 6, and an upper portion 2b, which is vertically adjustable in relation to the lower portion 2a. An eccentric having in this embodiment the form of an eccentric sleeve 10 is rotatably arranged about the lower portion 2a of the shaft 2. The eccentric sleeve 10 is provided with a first envelope surface 10a and a second envelope surface 10b, the second envelope surface 10b being eccentrically arranged relative to the first envelope surface 10a.

The circumferential surface of the shaft 2 provides a third envelope surface 2c extending about a central axis A and having a longitudinal extension along the central axis A.

A crushing head 12 is rotatably supported on the upper portion 2b of the shaft 2.

The eccentric sleeve 10 is radially supported by and rotatable about the shaft 2 via a first (inner) slide bearing 34a and a second (inner) slide bearing 34b. In the depicted embodiment, the inner slide bearings 34a, 34b comprise an optional respective inner bearing lining 36a, 36b of a material different from the material of the shaft 2 and the eccentric sleeve 10. The inner slide bearings 34a, 34b are lubricated.

The crusher head 12 is radially supported by and rotatable about the eccentric sleeve 10 via a third (outer) slide bearing 38a and a fourth (outer) slide bearing 38b. In the depicted embodiment, also the outer slide bearings 38a, 38b comprise an optional respective outer bearing lining 40a, 40b, of a material different from the material of the eccentric sleeve 10 and the crushing head 12. Together, the inner and outer slide bearings 34a, 34b, 38a, 38b of the eccentric sleeve 10 form an eccentric bearing arrangement for guiding the crushing head 12 along a gyratory path.

The upper portion 2b of the shaft 2 is provided with a bowl-shaped sliding bearing surface 2d. The crushing head 12 is provided with a ball-shaped sliding surface 12d. The crushing head 12 is thereby rotatably and pivotably supported by the upper portion 2b of the shaft 2.

A drive shaft 14 is connected to a drive motor (not shown) and is provided with a pinion 14b. The drive shaft 14 is arranged to rotate the eccentric sleeve 10 by the pinion 14b engaging a gear rim 15 mounted on the eccentric sleeve 10.

When the drive shaft 14 rotates the eccentric sleeve 10, during operation of the crusher 1, the crushing head 12 mounted thereon will execute a gyrating movement.

An inner crushing shell 20 is mounted on the crushing head 12. An outer crushing shell 22 is mounted on the frame top part 8. A crushing gap 24 is formed between the two crushing shells 20, 22. When the crusher 1 is operated, material to be crushed is introduced in the crushing gap 24 and is crushed between the inner crushing shell 20 and the outer crushing shell 22 as a result of the gyrating movement of the crushing head 12, during which movement the two crushing shells 20, 22 approach one another along a rotating generatrix and move away from one another along a diametrically opposed generatrix.

The upper portion 2b of the shaft 2 and the lower portion 2a of the shaft 2 are in the disclosed embodiment associated with a crushing head shaft piston 30. In the depicted embodiment, the upper portion 2b forms basically a piston and the lower portion 2a forms basically a cylinder relative to which the piston is moveable. The vertical position H of the crushing head 12 may thus be adjusted by operation of the crushing head shaft piston 30. The crushing head shaft piston 30 may be hydraulically adjusted by controlling the amount of hydraulic fluid in a hydraulic fluid space 32 at the lower end of the piston 30. Thereby, the width of the crushing gap 24 may be adjusted. Alternatively to or as a complement to the shaft piston 30, the bottom part 6 and top part 8 of the frame 4 may be vertically adjustable in relation to each other. This vertical adjustment may be provided by a threaded engagement 7 between the two parts 6, 8.

In accordance with an alternative embodiment the eccentric sleeve 10 may itself be manufactured from a bearing material. In such a case one or both of the inner and outer bearing linings 36a, 36b, 40a, 40b may be made from the same material as the eccentric sleeve 10. According to a further embodiment, one or both of the inner and outer bearing linings 36a, 36b, 40a, 40b may be integral with the eccentric sleeve 10 itself. The latter may, for example, be achieved by a portion of the inner periphery of the eccentric sleeve 10 being arranged for functioning as an inner bearing lining, and/or a portion of the outer periphery of the eccentric sleeve 10 being arranged for functioning as an outer bearing lining. Thus, the eccentric 10 could comprise integral slide bearings 34a, 34b on its inner side, integral slide bearings 38a, 38b on its outer side, or integral slide bearings 34a, 34b, 38a, 38b on both its inner and outer sides.

Returning now to FIG. 1, the inner slide bearings 34a, 34b define an eccentric sleeve axis of rotation A, about which the eccentric sleeve 10 is arranged to rotate. Thereby, the eccentric sleeve axis A also defines the centre of the gyratory motion of the crushing head 12. The eccentric sleeve axis of rotation A is fixed relative to the frame 4.

Similarly, the outer slide bearings 38a, 38b define a crushing head axis of rotation B, about which the crushing head 12 is arranged to rotate. The crushing head axis of rotation B is fixed relative to the eccentric sleeve 10, and is inclined and/or offset relative to said eccentric sleeve axis of rotation A, such that the crushing head axis B will gyrate about the eccentric sleeve axis A when the crusher 1 is operated.

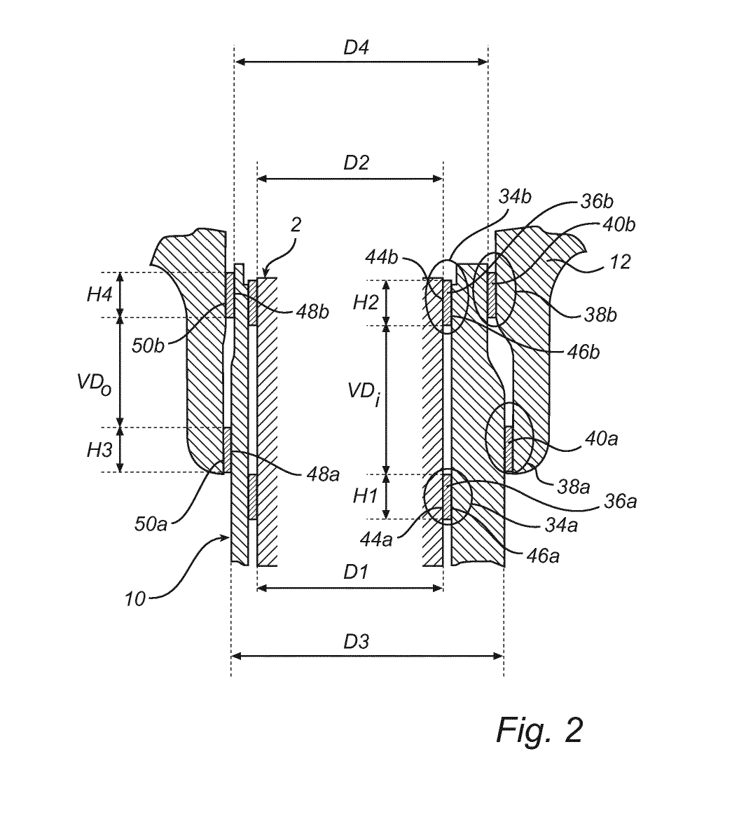

As shown in FIG. 2, the first (inner) slide bearing 34a has a diameter D1, which is defined as the diameter of the inner slide surface 44a of the eccentric sleeve 10 at the first (inner) slide bearing 34a. The second (inner) slide bearing 34b has a diameter D2, which is defined as the diameter of the inner slide surface 44b of the eccentric sleeve 10 at the second (inner) slide bearing 34b. In the disclosed embodiment the two inner diameters D1 and D2 are equal. In an alternative embodiment the two inner diameters D1 and D2 are different, with the first inner diameter D1 being larger than the second inner diameter D2. In yet another alternative embodiment the two inner diameters D1 and D2 are different, with the first inner diameter D1 being smaller than the second inner diameter D2.

The third (outer) slide bearing 38a has a diameter D3, which is defined as the diameter of the inner slide surface 48a of the eccentric sleeve 10 at the third (outer) slide bearing 38a. The fourth (outer) slide bearing 38b has a diameter D4, which is defined as the diameter of the inner slide surface 48b of the eccentric sleeve 10 at the fourth (outer) slide bearing 38b.

In the disclosed embodiment the two outer diameters D3 and D4 are different, the third diameter D3 being larger than the fourth diameter D4. In an alternative embodiment the two outer diameters D3 and D4 are equal. In yet another embodiment the third diameter D3 is smaller than the fourth diameter D4.

The first inner slide bearing 34a has a height H1, defined as the lowest of the height of the inner slide surface 46a of the eccentric sleeve 10 and the height of the slide surface 44a of the shaft 2 facing the inner slide surface 46a of the eccentric sleeve 10. The second inner slide bearing 34b has a height H2, defined as the lowest of the height of the inner slide surface 46b of the eccentric sleeve 10 and the height of the slide surface 44b of the shaft 2 facing the inner slide surface 46b of the eccentric sleeve 10. The third, outer slide bearing 38a has a height H3, defined as the lowest of the height of the outer slide surface 48a of the eccentric sleeve 10 and the height of the slide surface 50a of the crushing head 12 facing the outer slide surface 48a of the eccentric sleeve 10. The fourth, outer slide bearing 38b has a height H4, defined as the lowest of the height of the outer slide surface 48b of the eccentric sleeve 10 and the height of the slide surface 50b of the crushing head 12 facing the outer slide surface 48b of the eccentric sleeve 10.

Each of the slide surfaces 44a, 44b, 46a, 46b, 48a, 48b, 50a, 50b of the inner and outer slide bearings 34a, 34b, 38a, 38b, are illustrated as a single, continuous slide surface. However, a plurality of adjacent, vertically separated slide surface portions may form part of a single, aggregate slide surface; for such an aggregate slide surface, the total height is to be considered as the sum of the heights of the individual slide surface portions. It may e.g. be suitable to arrange one or more essentially circumferentially extending grooves, for example lubrication grooves, in one or more of the slide surfaces 44a, 44b, 46a, 46b, 48a, 48b, 50a, 50b of the inner and outer slide bearings 34a, 34b, 38a, 38b.

In accordance with one example, the first slide bearing 34a has a total height-to-diameter quotient H1/D1 of about 0.3. The second slide bearing 34b has a total height-to-diameter quotient H2/D2 of about 0.4. The third slide bearing 38a has a total height-to-diameter quotient H3/D3 of about 0.2. The fourth slide bearing 38b has a total height-to-diameter quotient H4/D4 of about 0.25.

The first and second slide bearings 34a, 34b are vertically separated along the central axis A a distance VDi such that a distance-to-height quotient (VDi/H1 or VDi/H2) of the one of the first or second slide bearing that has the greatest height is greater than 0.8, more preferably greater than 1.0, and most preferably greater than 1.3. In accordance with one example, the distance VDi is approximately 2.5 times the height H1, and approximately 2 times the height H2. Hence, the distance-to-height quotient, VDi/H1, VDi/H2, of the first and second slide bearing that has the greatest height, in this example the second bearing 34b having the height H2, is approximately 2.0. The distance VDi is defined as the shortest vertical distance between a point of sliding contact of the first slide bearing 34a and a point of sliding contact of the second slide bearing 34b. Preferably, the distance-to-height quotient (VDi/H1, VDi/H2) of the first or second slide bearing that has the greatest height is less than 6.0. A quotient (VDi/H1, VDi/H2) of more than 6.0 tends to result in a crusher which is higher than what is normally found efficient.

The sliding may occur at the interface between the eccentric 10 and the shaft 2 in case the slide surfaces of the first slide bearing 34a are integrally formed in the eccentric 10 and/or the shaft 2. If the first slide bearing 34a is provided with a bearing lining 36a, the sliding at the first slide bearing 34a may occur at the interface between the shaft 2 and the first bearing lining 36a and/or at the interface between the eccentric 10 and the first bearing lining 36a. Hence, if a bearing lining 36a is provided, then the sliding may occur at the slide surface 44a or at the slide surface 46a, or at both slide surfaces 44a, 46a, depending on whether the bearing lining 36a is mounted on the eccentric 10, on the shaft 2, or is not mounted on any of them.

Furthermore, the sliding may occur at the interface between the eccentric 10 and the shaft 2 in case the slide surfaces of the second slide bearing 34b are integrally formed in the eccentric 10 and/or the shaft 2. If the second slide bearing 34b is provided with a bearing lining 36b, the sliding at the second slide bearing 34b may occur at the interface between the shaft 2 and the second bearing lining 36b and/or at the interface between the eccentric 10 and the second bearing lining 36b. Hence, if a bearing lining 36b is provided, then the sliding may occur at the slide surface 44b or at the slide surface 46b, or at both slide surfaces 44b, 46b, depending on whether the bearing lining 36b is mounted on the eccentric 10, on the shaft 2, or is not mounted on any of them.

The third and fourth slide bearings 38a, 38b are vertically separated along the central axis A a distance VDo such that a distance-to-height quotient (VDo/H3 or VDo/H4) of the one of the third or fourth slide bearing that has the greatest height is greater than 0.8, more preferably greater than 1.0. In one example, the distance VDo is approximately 1.6 times the height H3, and approximately 1.5 times the height H4. Hence, the distance-to-height quotient, VDo/H3, VDo/H4, of the third and fourth slide bearing that has the greatest height, in this embodiment the fourth bearing 38b having the height H4, is approximately 1.5. The distance VDo is defined as the shortest vertical distance between a point of sliding contact of the third slide bearing 38a and a point of sliding contact of the fourth slide bearing 38b. In the event that one of the slide bearings 38a, 38b moves together with the crushing head 12, while the other one of the slide bearings 38a, 38b is connected to the eccentric 10, the distance VDo may change as the vertical position of the crushing head 12 is adjusted. In such case, the distance-to-height quotient (VDo/H3 or VDo/H4) is calculated based on the shortest vertical distance VDo during such adjustment. Preferably, the distance-to-height quotient (VDo/H3, VDo/H4) of the third or fourth slide bearing that has the greatest height is less than 6.0. A quotient (VDo/H3, VDo/H4) of more than 6.0 tends to result in a crusher which is higher than what is normally found efficient.

The sliding may occur at the interface between the eccentric 10 and the crushing head 12 in case the slide surfaces of the third slide bearing 38a are integrally formed in the eccentric 10 and/or the crushing head 12. If the third slide bearing 38a is provided with a bearing lining 40a, the sliding at the third slide bearing 38a may occur at the interface between the crushing head 12 and the third bearing lining 40a and/or at the interface between the eccentric 10 and the third bearing lining 40a. Hence, if a bearing lining 40a is provided, then the sliding may occur at the slide surface 48a or at the slide surface 50a, or at both slide surfaces 48a, 50a, depending on whether the bearing lining 40a is mounted on the crushing head 12, on the eccentric 10, or is not mounted on any of them.

Furthermore, the sliding may occur at the interface between the eccentric 10 and the crushing head 12 in case the slide surfaces of the fourth slide bearing 38b are integrally formed in the eccentric 10 and/or the crushing head 12. If the fourth slide bearing 38b is provided with a bearing lining 40b, the sliding at the fourth slide bearing 38b may occur at the interface between the crushing head 12 and the fourth bearing lining 40b and/or at the interface between the eccentric 10 and the fourth bearing lining 40b. Hence, if a bearing lining 40b is provided, then the sliding may occur at the slide surface 48b or at the slide surface 50b, or at both slide surfaces 48b, 50b, depending on whether the bearing lining 40b is mounted on the crushing head 12, on the eccentric 10, or is not mounted on any of them.

Furthermore, the inner and outer slide bearing linings 36a, 36b, 40a, 40b are typically fabricated in a relatively expensive soft metal alloy; the reduction of the total height of the bearing linings 36a, 36b, 40a, 40b represents a significant cost saving.

The vertical travel length, depicted with HL in FIG. 1, is the vertical range within which the vertical position of the crushing head 12 can be adjusted by supplying more or less hydraulic fluid to the hydraulic fluid space 32 which supports the sliding bearing surface 2d and the crushing head 12 resting thereupon. The vertical travel length HL of the crusher 1 is determined by the design of the hydraulic piston 30 and the design of the slide bearings 34a, 34b, 38a, 38b. Often the slide bearings are the factor limiting the vertical travel length HL. As an additional benefit of dividing and separating the slide bearings, for crushers having a crushing gap 24 that is adjustable by vertically adjusting the crushing head 12 by means of the piston 30, and/or a crushing gap 24 that is adjustable by vertically adjusting the frame top part 8 by means of the thread 7, it becomes easier to design the crusher to allow for an increased vertical travel length HL of the crushing head 12. By allowing an increased vertical travel length HL it becomes possible to use inner and/or outer crushing shell(s) 20, 22 with a greater material thickness, and hence a longer life, since the crushing head 12 may be vertically adjusted along a longer vertical travel length HL as the crushing shells 20, 22 are worn as an effect of the crushing of material. Thicker crushing shells 20, 22 make it possible to operate the crusher 1 with a longer service interval.

In order to fully take benefit of the reduced height of the slide bearings 34a, 34b, 38a, 38b by increasing the thickness of the crushing shells 20, 22, a quotient, i.e. HL/D, between the maximum vertical travel length HL of the crushing head 12 and the horizontal diameter D of the crushing head 12 preferably exceeds 0.16. More preferably HL/D exceeds 0.18, and even more preferably HL/D exceeds 0.24.

Furthermore, the reduction of the total height of the slide surfaces of the inner and/or outer slide bearings 34a, 34b, 38a, 38b results in a reduced bearing friction. The reduced friction may reduce the total power consumption of the bearing arrangement by about 30%, which reduces the cost of operating the crusher 1. Moreover, reduced friction reduces the risk of the crushing head 12 starting to spin at high RPM when no material to be crushed is present in the crushing gap 24.

Preferably, for reliable operation, each of the slide bearings 34a, 34b, 38a, 38b has a relative clearance ξ of between about 2*10⁻⁴ and about 5*10⁻³, respectively. By way of example, a diameter D1 of the slide bearing 34a may be 300 mm. By multiplying such diameter D1 by a suitable relative clearance a diametral clearance, in mm, can be obtained. For a diameter D1 of 300 mm, and a relative clearance ξ of 3*10⁻³ a diametral clearance of the slide bearing 34a may, for example, be 3*10⁻³*300 mm=0.9 mm.

The Sommerfeld number, S, described in, for example, Shigley, Joseph Edward; Mischke, Charles R. (1989). Mechanical Engineering Design. New York: McGraw-Hill, page 483, is a number that takes into account both the physical features of a slide bearing and the conditions under which the slide bearing operates. Each of the slide bearings 34a, 34b, 38a, 38b may preferably have a Sommerfeld number, S, which is less than 120. Preferably, the Sommerfeld number, S, of each of the slide bearings 34a, 34b, 38a, 38b is less than 70, and more preferably the Sommerfeld number, S, is less than 40, and even more preferably the Sommerfeld number, S, is less than 20. Such values of the Sommerfeld number, S, of the slide bearings 34a, 34b, 38a, 38b have been found to improve the capacity of the slide bearings 34a, 34b, 38a, 38b to operate at high crushing loads also at low height-to-diameter quotients H1/D1, H2/D2, H3/D3, H4/D4 respectively. Preferably, the Sommerfeld number is higher than 2, and more preferably higher than 3, and even more preferably above 4, since a lower Sommerfeld number tends to increase the investment and operating costs. Thereby, the bearing will be suited for a lubricant having a typical viscosity, according to the ISO-VG scale, of between 100 and 460.

A typical RPM of the crusher 1, when operated, may be between about 150 rpm and about 500 rpm as measured at the eccentric sleeve 10; the RPM may typically be selected so as to obtain a sliding speed in each of the inner and outer slide bearings of between about 2 m/s and about 20 m/s.

The invention has mainly been described above with reference to a single embodiment. However, as is readily appreciated by a person skilled in the art, other embodiments than the ones disclosed above are equally possible within the scope of the invention, as defined by the appended patent claims.

Furthermore, the teachings disclosed herein are also valid for crushers that are not provided with central shaft but instead are provided with a central hub with an internal envelope surface. A crusher of this kind is e.g. disclosed in U.S. Pat. No. 3,325,108 A. In such a design the central hub has an internal envelope surface (which corresponds to the outside of the shaft in the depicted embodiment). The internal envelope surface is centred and fixed relative to a central axis (c.f. axis A). The eccentric is placed inside the hub and is rotated inside the internal envelope surface of the hub. The eccentric is provided with an internal envelope surface which is concentric to the outer envelope surface of the eccentric. A shaft, connected to the crushing head, is journalled to the inside envelope surface of the eccentric. In the interface between the hub and the eccentric there is provided an upper and a lower slide bearing (c.f. slide bearings 34a, 34b between the shaft 2 and the eccentric 10). In the interface between the eccentric and the crushing head shaft there is provided an upper and a lower slide bearing (c.f. slide bearings 38a, 38b). Thus, the inventive design with slide bearings that are separated from each other may also be used in the kind of set-up disclosed in U.S. Pat. No. 3,325,108 A.

1. A gyratory crusher comprising:
a crushing head provided with a first crushing shell;
a frame provided with a second crushing shell, wherein the first and second crushing shells between them define a crushing gap;
an eccentric provided with a first envelope surface and a second envelope surface, the second envelope surface being eccentrically arranged relative to the first envelope surface;
a third envelope surface extending about a central axis and having a longitudinal extension along said central axis, wherein the first envelope surface of the eccentric being journalled to the third envelope surface and arranged to rotate about said central axis, and the second envelope surface of the eccentric being journalled to the crushing head, whereby rotation of the eccentric will provide a gyratory movement to the crushing head; and
a first slide bearing and a second slide bearing provided between the first and third envelope surfaces, wherein the first and second slide bearings are vertically separated from each other along said central axis a distance (VDi) such that a distance-to-height quotient (VDi/H1; VDi/H2) of the first or second slide bearing that has the greatest height (H1; H2) is greater than 0.8.

2. A gyratory crusher according to claim 1, wherein the first and second slide bearings each has a respective height (H1, H2) along and a respective diameter (D1, D2) about said central axis such that a height-to-diameter quotient (H1/D1; H2/D2) of each of the first and second slide bearings is less than 0.8.

3. A gyratory crusher according to claim 2, wherein the height-to-diameter quotient (H1/D1, H2/D2) of each of the first and second slide bearings is larger than 0.12.

4. A gyratory crusher according to claim 1, wherein the crushing head and the frame are vertically movable relative to each other so as to allow changing the width of the crushing gap, wherein a quotient (HL/D) between the maximum vertical travel length (HL) of the crushing head and the horizontal diameter (D) of the crushing head exceeds 0.16.

5. A gyratory crusher according to claim 1, wherein the second envelope surface of the eccentric is journalled to a fourth envelope surface of the crushing head, wherein a third and a fourth slide bearing are provided between the second and fourth envelope surfaces.

6. A gyratory crusher according to claim 5, wherein the third and fourth slide bearings each has a respective height (H3, H4) along and a respective diameter (D3, D4) about said central axis such that a height-to-diameter quotient (H3/D3, H4/D4) of each of the third and fourth slide bearings is less than 0.45.

7. A gyratory crusher according to any claim 5, wherein the third and fourth slide bearings are vertically separated from each other along said central axis a distance (VDo) such that a distance-to-height quotient (VDo/H3; VDo/H4) of the third or fourth slide bearing that has the greatest height (H3; H4) is greater than 0.8.

8. A gyratory crusher according to claim 5, wherein the height-to-diameter quotient (H3/D3, H4/D4) of each of the third and fourth slide bearing is more than 0.08.

9. A gyratory crusher according to claim 1, wherein the third envelope surface is an outwardly facing envelope surface of a central shaft body.

10. A gyratory crusher slide bearing lining for rotatably mounting a crushing head to a crusher frame via an eccentric, wherein a first and a second slide bearing lining form part of a set of slide bearing linings, the first and second slide bearing linings arranged to be mounted vertically separated from each other at a distance (VDi, VDo) such that a distance-to-height quotient (VDi/H1, VDi/H2; VDo/H3, VDo/H4) of the first or second slide bearing lining that has the greatest height (H1, H2; H3, H4) is greater than 0.8.

11. A gyratory crusher slide bearing lining according to claim 10, wherein the slide bearing lining is arranged between a crusher shaft and the eccentric.

12. A gyratory crusher slide bearing lining according to claim 11, wherein the slide bearing lining (36a, 36b) has a height (H1, H2) and a diameter (D1, D2) such that a height-to-diameter quotient (H1/D1; H2/D2) of the slide bearing lining is less than 0.8.

13. A gyratory crusher slide bearing lining according to claim 10, wherein the slide bearing lining is adapted to be arranged between the eccentric and the crushing head.

14. A gyratory crusher slide bearing lining according to claim 13, wherein the slide bearing lining has a height (H3, H4) and a diameter (D3, D4) such that a height-to-diameter quotient (H3/D3; H4/D4) of the slide bearing lining is less than 0.45.

15. A gyratory crusher slide bearing lining according to claim 10, wherein the slide bearing lining is arranged to be mounted on the eccentric.

16. A set of gyratory crusher slide bearing linings, comprising a first slide bearing lining and a second slide bearing lining, the first and second slide bearing linings-arranged to be mounted vertically separated from each other at a distance (VDi, VDo) such that a distance-to-height quotient (VDi/H1, VDi/H2; VDo/H3, VDo/H4) of the first or second slide bearing lining that has the greatest height (H1, H2; H3, H4) is greater than 0.8.

17. A gyratory crusher eccentric comprising first and second slide bearings that are vertically separated from each other a distance (VDi; VDo) such that a distance-to-height quotient (VDi/H1, VDi/H2; VDo/H3, VDo/H4) of the first or second slide bearing that has the greatest height (H1, H2; H3, H4) is greater than 0.8.

18. A gyratory crusher according to claim 4, wherein the quotient (HL/D) between the maximum vertical travel length (HL) of the crushing head and the horizontal diameter (D) of the crushing head preferably exceeds 0.18

19. A gyratory crusher according to claim 4, wherein the quotient (HL/D) between the maximum vertical travel length (HL) of the crushing head and the horizontal diameter (D) of the crushing head preferably exceeds 0.24.

20. A gyratory crusher according to claim 6, wherein the height-to-diameter quotient (H3/D3, H4/D4) of each of the third and fourth slide bearings is less than 0.35.
